(19) United States
(12) Patent Application Publication
(10) Pub. No.: US 2026/0145344 A1
(43) Pub. Date: May 28, 2026

(54) HYBRID SUCTION END OF ARM TOOLS HAVING DYNAMICALLY VARIABLE SUCTION ARRAYS

(71) Applicant: Amazon Technologies, Inc., Seattle, WA (US)

(72) Inventors: Erik Herold, Melrose, MA (US); Philip Sieg, Cambridge, MA (US)

(73) Assignee: Amazon Technologies, Inc., Seattle, WA (US)

(21) Appl. No.: 18/961,162

(22) Filed: Nov. 26, 2024

(51) Int. Cl. B25J 15/06

(52) U.S. Cl. CPC B25J 15/0616

(57) ABSTRACT

Systems and methods are disclosed for hybrid suction end of arm tools having dynamically variable suction arrays and related item manipulation devices. In one embodiment, an example item manipulation device may include a housing, a first suction cup assembly having a first suction cup and a first suction cup support arm, where the first suction cup support arm is configured to rotate with respect to the housing, and a second suction cup assembly having a second suction cup and a second suction cup support arm, where the second suction cup support arm is configured to rotate with respect to the housing. At least one of the first suction cup assembly and the second suction cup assembly can be configured to move relative to the other.

### BACKGROUND

As users increasingly make online purchases, fulfilment of such purchases and other orders may become increasingly complicated. For example, a fulfillment center may have output of upwards of one million packages per day. With such demands, efficiency of logistics related to processing orders and packages may be important. Accordingly, improvements in various operations of order fulfillment, such as improvements to picking technology, sorting technology, packing technology, and so forth may be desired, such that manual efforts can be redirected to different tasks.

### BRIEF DESCRIPTION OF THE DRAWINGS

FIGS. 1A-1B are hybrid schematic illustrations of an example use case for hybrid suction end of arm tools having dynamically variable suction arrays and an example process flow in accordance with one or more embodiments of the disclosure.

FIG. 2 is a schematic illustration of an example item manipulation system for moving items in accordance with one or more embodiments of the disclosure.

FIG. 3 is a schematic illustration of an item manipulation device in accordance with one or more embodiments of the disclosure.

FIGS. 4A-4B are schematic illustrations of an end of arm tool with engagement members and suction cup assemblies in various configurations in accordance with one or more embodiments of the disclosure.

FIG. 5 is a schematic illustration of an end of arm tool with engagement members and suction cup assemblies in various configurations in accordance with one or more embodiments of the disclosure.

FIG. 6 is a schematic illustration of an end of arm tool in an expanded configuration in accordance with one or more embodiments of the disclosure.

FIG. 7 schematically illustrates an example architecture of a computer system associated with an item manipulation device in accordance with one or more embodiments of the disclosure.

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

### Overview

Fulfillment centers may be used to fulfill online purchases and other orders. For example, fulfillment centers may include product inventory that may be pulled when an order for a particular product or multiple products is placed. In some instances, the product(s) may be packed and shipped from the fulfillment center. However, the process of obtaining the product(s), packing the product(s), and shipping the product(s) may be complicated due to the amount of inventory, the number of orders to process, the size of the fulfillment center, and/or other factors. In addition, a portion of the fulfillment center designated for packing or shipping may be different than the portion of the fulfillment center designated for holding product inventory. As a result, transportation of products in an order may be time consuming.

Moving items or objects through a fulfillment center may require handling of the item itself. For example, picking the item from inventory, placing the item into a container, removing the item from a container, and so forth may all be examples of actions for which an item may need to be handled. In addition, different items may have different types of packaging. For example, some items may come in boxes, some items may come in loose bags, some items may come shrink wrapped, some items may not have any packaging, and so forth. In addition, retrieving a certain number of items, such as singular items, or multiple items in cluttered environments (e.g., stacked on top of each other or otherwise in a number of layers, etc.), may be difficult, and may depend on a type of packaging in which the item comes with. Humans may be able to manually handle individual items with ease. However, robotic handling of items may require various levels of dexterity. Similarly, when retrieving items from cluttered areas, such as a single item from a bin full of items, robotic manipulators may be limited by an exposed area of the item to be grasped, and so forth. Moreover, certain items, such as books, shoeboxes, and the like may be difficult to grasp using robotic manipulators due to a tendency for the item to open or for its weight to shift once lifted.

Picking items using a robot end-of-arm tool that allows pinching of an item can be best suited to retrieve articulated items, such as telescopic boxes, books with dust jackets, etc. from tote containers, because pinch-grasping may prevent robot-induced damage via pinching on multiple surfaces of an item. However, such type of pinch-grasping is not always feasible due to space constraints, since pinch-grasping relies on free space surrounding an item to fit engagement fingers about the side of the item. For example, when an item is very close to a sidewall of a container from which it will be grasped, direct pinch-grasping of this item may not be possible due to collision with the sidewall. Moreover, when suction alone is insufficient to pick items, dynamically variable suction arrays may be desired, as described herein.

Embodiments of the disclosure include end of arm tools or item manipulation devices that include dynamically variable suction arrays that allow for different suction cup assemblies to be positioned and/or moved in lateral and/or vertical positions independent of one another. Some embodiments include a set of mechanical fingers that allow for increased flexibility in grasping items with or without the use of suction. For some items, particularly in cluttered environments, suction may be difficult to apply, and may result in mis-picks, or grasping of multiple items. For other items, such as books, suction alone may be insufficient to grasp the item. Certain embodiments allow for the use of fingers with or without suction to grasp items from side and/or bottom surfaces, leading to an increased range of items that can accurately be grasped, as well as improved performance in cluttered environments.

In some embodiments, end of arm tools may include one or more 4-bar linkages, which can maintain horizontal or near-horizontal positioning of the suction arrays as the angular position of the driven links change. This enables a highly positionable suction array which can be varied based on the item to be grasped, allowing for increased geometric and moment eligibility. Embodiments can include any number of suction cup assemblies with corresponding 4-bar (or other types) of linkages placed about one or more driven gears, belts, or other transmission components. Although described in the context of suction cup assemblies having suction cups, any type of suction device or end effector may be used, including suction cups having various geometrical configurations and material properties, as well as foam pads or other types of porous suction end points, ball or point tips, and/or other types of components configured to direct air pressure and/or suction. Certain embodiments may include larger array spacings, with the benefit of the height of the tool being reduced and the item grasped being held with reduced offset from the robotic manipulator wrist. This improves robotic manipulator loading conditions, as the reduced height offset from the robotic manipulator wrist improves payload performance. Various actuation mechanisms may be used, such as a brushless DC motor that rotates a gear, where the gear symmetrically rotates gears keyed to each driven linkage (e.g., a gearbox, etc.). Some embodiments include a passive linear compliance mechanism mounted between the fingers and actuation mechanism. The floating link can include the suction array. In such embodiments, a pneumatically actuated cylinder can be used to extend and retract the suction cup. Some embodiments include a passively wristed suction cup assembly, which allows for passive rotation of the suction array.

Some embodiments include a cam-based mechanism for deployment of the fingers, where a linear stage (e.g., motor and leadscrew, etc.) are coupled with a pivoting cam mechanism, thereby allowing for sequential linear and rotary actuation with a single actively controlled degree of freedom. As a result, both deployment and size adjustment can be controlled using a single actuator, so as to accommodate a wide range of item sizes. Some embodiments have mechanical fingers with extendable suction pistons.

Embodiments of the disclosure therefore include methods and systems for hybrid suction end of arm tools having dynamically variable suction arrays. The end of arm tools may be configured to handle many different types of items from cluttered and uncluttered environments. Such end of arm tools may have improved control over items, reduce a likelihood of item damage, and provide smoother unloading or ejection of items. Some embodiments include suction cup-based end effectors or end of arm tools that apply a vertical motion downforce is used, where deployable fingers can be positioned around the item, so as form a “cage” around the item. This allows for grasping of items such as books, shoeboxes, and other items that may shift weight and/or be problematic to grasp and move using robotic manipulators. Certain embodiments include actuator-driven engagement members that can be used to deploy fingers both in linear and rotational directions, which, in combination with suction cup assemblies, allows for grasping and transport of previously unmanageable items. Some embodiments include optimized process flows for processing of orders at fulfillment centers, as well as process flows or methods to increase speed of transporting items as a result of improved item handling. As a result, throughput of fulfillment centers may be improved, and/or logistics of fulfillment center operations may be less complicated.

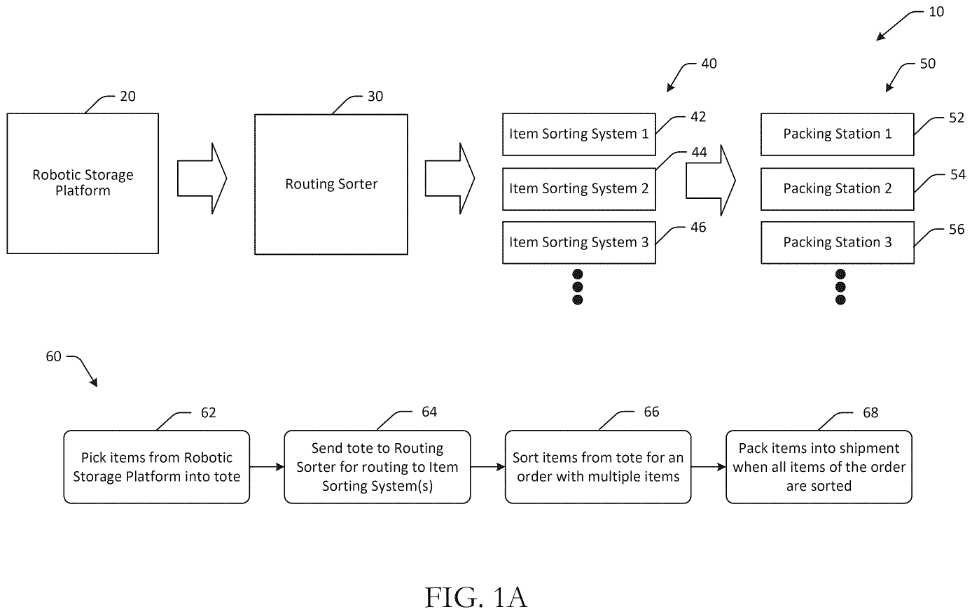

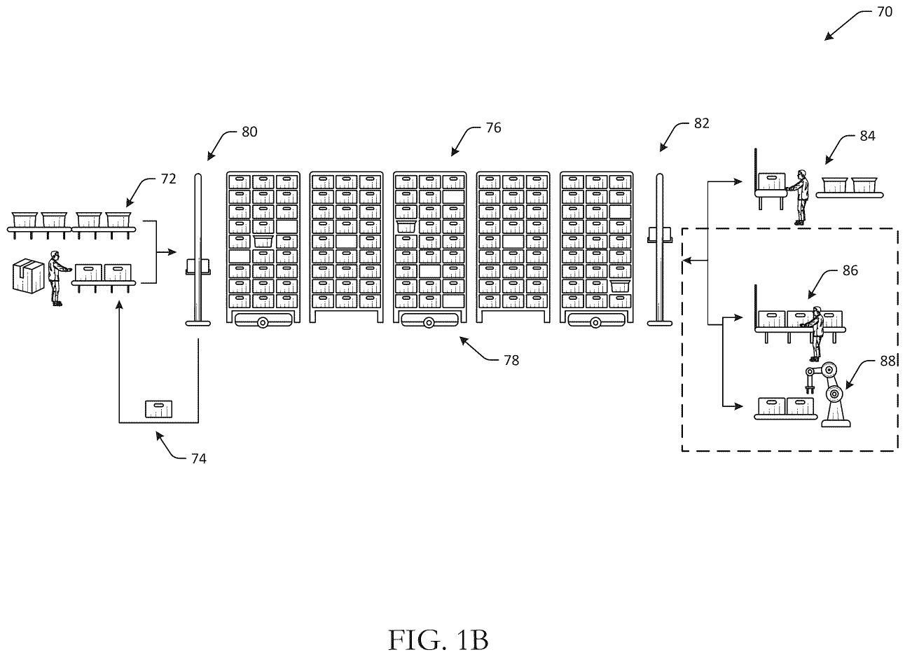

Referring to FIGS. 1A-1B, an example use case 10 for hybrid suction end of arm tools having dynamically variable suction arrays and an example process flow in accordance with one or more embodiments of the disclosure. Although discussed in the context of online orders, other embodiments may be directed to any suitable use case where products or containers are picked and/or sorted, or packages are sorted, such as instances where users may pick up orders rather than receiving a shipment, instances where items are aggregated for transport to another fulfillment center, and so forth.

In FIG. 1A, a fulfillment center may include a robotic storage platform 20, a routing sorter 30, one or more item sorting systems 40, and one or more packing stations 50. The robotic storage platform 20 may be a portion of the fulfillment center at which products picked from product inventory are placed. Inventory may be stored in containers in flexible container pods in some instances. Robots may be used with end of arm tools described herein to pick products from inventory and/or to deliver to the robotic storage platform in some instances, while in other instances, manual effort or a combination thereof may be used to pick products. The picking process at the robotic storage platform may include locating a product in an order, obtaining the product, and sending the product to the robotic storage platform 20, such as via a conveyor belt. In the illustrated embodiment, products at the robotic storage platform 20 may be placed in a container, such as a tote. The tote may optionally be assigned to, or otherwise associated with, a particular item sorting system machine in some instances. For example, a certain tote may be associated with a certain item sorting system, such that products that are designated to be picked and placed in the tote are for orders that are to be consolidated at that particular item sorting system. The association between the tote and the item sorting system may be static in some instances. In other embodiments, there may not be any association between totes and item sorting systems, or associations may be dynamic.

At the routing sorter 30, totes including products that have been picked may be routed to the appropriate or designated item sorting system. For example, the routing sorter 30 may optionally determine an identifier associated with the tote, and may determine one or more item sorting systems to which the tote is to be routed using the identifier or using another factor, such as sortation system load. The routing sorter 30 may route or direct the tote to an item sorting system.

The item sorting systems 40 may include one or more item sorting system machines. In FIG. 1A, a first item sorting system 42, a second item sorting system 44, a third item sorting system 46, and so forth may be included. Any number of item sorting systems may be included. Some or all of the item sorting systems may optionally be associated with certain totes. The item sorting systems may be used to consolidate or otherwise aggregate products for single or multi-item orders and/or for transfer to a different fulfillment center. For example, a first tote may include a first item of a multi-item order, and a second tote may include a second item of the multi-item order. The item sorting system may therefore identify the orders associated with the respective products in a tote, and may transport the products to a container, such as a tote, a flexible container, a specific chute leading to a container, or a different container associated with the order. When the order is complete with all of the products in the associated chute or container, the order may be packed. In instances where a container is designated for a different fulfillment center, as opposed to an online order, the container may be packed when full, as opposed to when certain items are placed into the container (e.g., there may not be any specific items that need to be in the container before packing, rather, the container may just be a certain threshold full, etc.). Accordingly, a specific item sorting system may be designated for fulfillment of a particular multi-item order. As a result, all of the products in the multi-item order may be placed in totes that are directed to that particular item sorting system. At the item sorting systems 40, totes that are received via the routing sorter 30 may be emptied, and the products in the respective totes may be transported to the appropriate chutes or containers for the orders for which the products were picked.

After a single or multi-item order is complete (e.g., the item sorting system has delivered all of the products in the order to the appropriate chute, container, etc.), or when a container designated for another fulfillment center is full (where full is a configurable threshold, such as about 60% full capacity, 70% full capacity, 80% full capacity, 90% full capacity, etc.), the order may be packed at the packing station 50. In some embodiments, one or more packing stations may be included. In some instances, a packing station may service more than one item sorting system, while in other instances, more than one packing station may service one item sorting system. In the illustration of FIG. 1A, a first packing station 52 may be used to pack orders from the first item sorting system 42, a second packing station 54 may be used to pack orders from the second item sorting system 44, a third packing station 56 may be used to pack orders from the third item sorting system 46, and so forth. At the packing stations 50, the orders may be placed into boxes and sealed for subsequent shipment. The packages may then be processed for shipment to the user. In another example, the containers may be stacked, closed, or otherwise packed for shipment to another fulfillment center.

At the fulfillment center, an example process flow 60 illustrated in FIG. 1A may be implemented to improve the efficiency and/or throughput of the fulfillment center. At a first block 62, items may be picked from the robotic storage platform 20 into a tote that may optionally be associated with a specific item sorting system. At a second block 64, the tote may be sent to the routing sorter 30 for routing to an item sorting system. At a third block 66, the items from the tote may be sorted for an order with multiple item by the specific item sorting system. At a fourth block 68, the items may be packed into a shipment when all of the items in the order are sorted.

In FIG. 1B, an example automated storage and retrieval environment 70 is depicted. The automated storage and retrieval environment 70 may be a containerized fulfillment center solution that stores inventory in totes and implements automated workflows. The automated storage and retrieval environment 70 may include a consolidation workflow, which involves combining inventory from emptier containers into fuller containers in order to ensure an automated induct process is not blocked due to insufficient empty/free spaces on container storage racks 76 for inserting new containers. Containerized inventory can flow through the automated storage and retrieval environment 70 via induct at containers 72 (which can include a decant process to move items to empty high capacity containers 74. A first gantry 80 may be used to load and/or unload containers from the container storage racks 76. The container storage racks 76 may be transported using autonomous robots 78. A second gantry 82 may be used to load and/or unload containers from the container storage racks 76. Containers may be moved downstream for manual or automated picking at a pick station 84, to a consolidation station 86 to consolidate items into fewer containers, and/or to robotic work cells 88 for automated picking and/or placement of items into or from containers.

Embodiments of the disclosure include hybrid suction end of arm tools having dynamically variable suction arrays and suction cups that are configured to handle and/or retrieve items from bins or containers, storage areas, conveyors, and so forth. Certain embodiments may improve processing speed and/or throughput of fulfillment centers. Certain embodiments may improve performance of mechanical equipment for sortation and/or consolidation of items. While described in the context of online orders, aspects of this disclosure are more broadly applicable to other forms of object handling.

Example embodiments of the disclosure provide a number of technical features or technical effects. For example, in accordance with example embodiments of the disclosure, certain embodiments of the disclosure may improve processing speed, throughput, and/or efficiency of fulfillment centers. The above examples of technical features and/or technical effects of example embodiments of the disclosure are merely illustrative and not exhaustive.

One or more illustrative embodiments of the disclosure have been described above. The above-described embodiments are merely illustrative of the scope of this disclosure and are not intended to be limiting in any way. Accordingly, variations, modifications, and equivalents of the embodiments disclosed herein are also within the scope of this disclosure. The above-described embodiments and additional and/or alternative embodiments of the disclosure will be described in detail hereinafter through reference to the accompanying drawings.

### Illustrative Embodiments and Use Cases

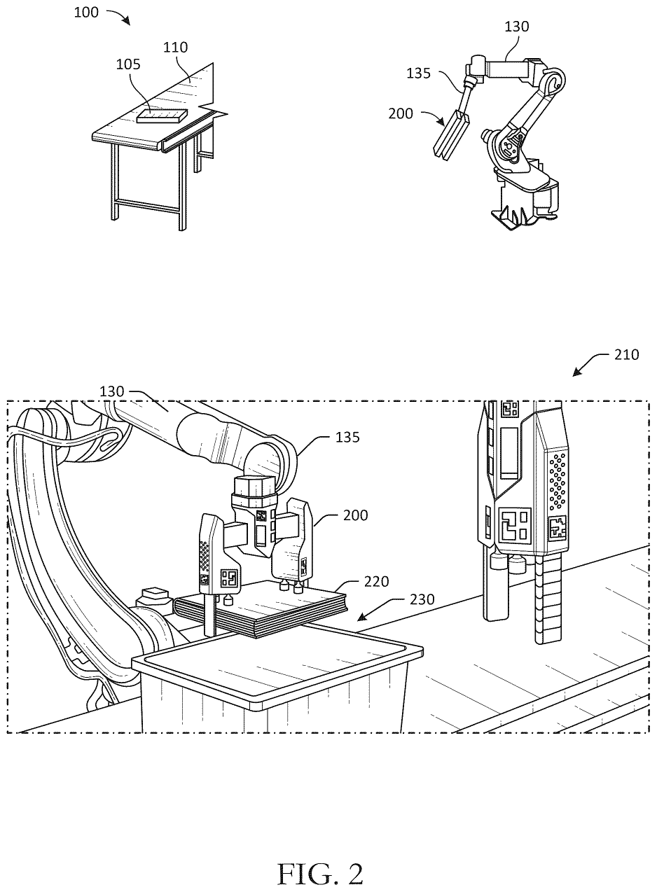

FIG. 2 is a schematic illustration of an example item manipulation system for moving items in accordance with one or more embodiments of the disclosure. Other embodiments may include additional or fewer components. The illustration of FIG. 2 may not be to scale, and may not be illustrated to scale with respect to other figures. The robotic manipulator and end of arm tool configured to grasp items illustrated in FIG. 2 may be used throughout the fulfillment center environment discussed with respect to FIGS. 1A-1B.

Inventory systems are utilized by many entities for storing and managing inventory. For example, some retailers may utilize a warehouse of racks that store items in various containers (also referred to as bins, storage locations, etc.). Items may be stowed in the various containers to hold the item in preparation for picking. For example, when an order for a specific item needs to be fulfilled by a retailer, the item can be picked (or retrieved) from the container where the item is stored. Inventory systems may use a mechanical system to stow an item into a container and/or pick an item from the container. The mechanical system may include a robotic arm that permits various sensors and end of arm tools (also referred to herein as end effectors and/or item manipulation devices) to interact with items outside and/or within multiple containers.

In some instances, the robotic arm uses an end of arm tool that can optionally manipulate existing items within a densely packed container in order to create space to retrieve a particular item. As described herein, after grasping an item with the end of arm tool, the robotic arm can move or transport the grasped item from a first location to a second location.

By using deployable engagement members (or mechanical fingers) and suction cup(s) to grasp and cage items, the end of arm tool may be configured to operate with various robotic manipulation systems, such as robotic arms, without complications due to weight and/or size requirements. For example, the engagement members may be stored in a minimal footprint when not in use. In addition, the placement of actuators, such as pneumatic actuators, to drive engagement member positioning may be aligned along vertical axes of the end of arm tool to reduce a likelihood of uncalibration and/or wear and tear on the robotic manipulator. Note that many of the embodiments herein describe an end of arm tool for a robotic arm in the context of grasping and lifting an item. In other embodiments, the end of arm tool described herein can be used for other operations, such as placing an item into a container. Further, as used herein, an “item” may refer to an individual item, multiple items, a package containing an individual item, a package containing multiple items, etc.

In FIG. 2, a stow or pick system 100 is depicted according to one embodiment. The system 100 may be located in a facility (e.g., warehouse, factory, distribution center, etc.). In one particular embodiment, the system 100 is a robotic stowing or picking system. The system 100 can be located in a fulfillment center that performs various operations in order to ship items 105 to customers. Here, the system 100 includes a conveyor 110 that can convey items to a robotic manipulator 130, where the robotic manipulator 130 may be configured to grasp the item 105. In some embodiments, the items may be singulated or spaced apart, whereas in other embodiments, the items may be cluttered together. In another environment 210, the robotic manipulator 130 may be configured to retrieve items 220 from a container 230, where the item may be the only item in the container 230, or may be cluttered with other items in the container 230.

In the depicted embodiment, the robotic manipulator 130 includes a mount 135, which can support various sensors and end of arm tools for stowing and/or picking items from the containers 230. Here, for example, the mount 135 supports an end of arm tool 200, which includes one or more engagement members and one or more suction cups for grasping, transporting, picking items from a container or other surface, and/or stowing items into a particular container. As noted, the end of arm tool 200 can grasp an item 105 located on the conveyor 110, in the container 230, and elsewhere.

One or more sensors may be included. The sensor(s) may be a visual sensor, depth sensor, infrared sensor, barcode reader, force sensing sensor, pressure sensor, gyroscope, accelerometer, or combinations thereof. The sensor(s) can be any sensor that permits the system 100 to identify occupied versus empty space in the container, identify the arrangement of items in the container, identify the type or number of items in the container, determine a target grasp point at which to grasp the item, determine an orientation of the end of arm tool 200, identify the individual items in the container, and the like. The sensor(s) can be disposed in different locations on the robotic manipulator 130 and/or end of arm tool 200. For example, the sensor(s) can be mounted to one or more of the components of the end of arm tool 200 to allow the end of arm tool 200 to determine the amount of force applied to an item when grasping the item.

In example embodiments, the end effectors described herein may include one or more suction cups to engage one or more portions of an item. In addition, the end effectors may include one or more grasping fingers or engagement members to grasp and cage an item. In some example embodiments, grasping of an item may comprise gripping, pinching, holding, squeezing, or otherwise grabbing an item via one or more portions of the item, and caging of an item may comprise surrounding, enveloping, encircling, restraining, constraining, or otherwise enclosing one or more portions, or substantially all portions, of an item.

The one or more grasping fingers or engagement members may move between at least two positions, e.g., an open position and a closed position. In the open position, the grasping fingers or engagement members may release an item, and in the closed position, the grasping fingers or engagement members may grasp an item. For example, various types of actuators, such as pneumatic actuators, servos, solenoids, motors, shape memory alloys, or combinations thereof, may cause the grasping fingers or engagement members to move between at least the open position and the closed position. Further, the grasping fingers or engagement members may be formed of various materials, such as silicone, rubber, plastics, composites, metals, or combinations thereof, that may provide flexibility, elasticity, and/or stiffness to portions of the grasping fingers, and may also have various friction properties to grasp an item.

Using a generated item grasp strategy for the item, a robotic arm and end effector may be instructed to grasp the item. For example, the robotic arm and end effector may be positioned and oriented based on the grasp point and/or approach trajectory. In addition, the robotic arm and end effector may initiate grasping of the item based on a grasping type (such as picking, scooping, sliding, pushing, turning, re-orienting, etc.), grasping sequence, suction forces, grasping forces, other forces, or other grasp characteristics of the item. Further, the robotic arm and end effector may move or transfer the grasped item based on a movement type, movement sequence, direction, speed, acceleration, or other movement characteristics of the item.

The end effectors and associated methods to grasp items described herein may enable reliable and efficient grasping of various types of items by using combinations of suction, grasping, pinching, sliding, scooping, lifting, caging, and/or other types of grasping movements. Further, the end effectors and associated methods to grasp items described herein may also reduce the potential for opening, stretching, ripping, tearing, dropping, or otherwise damaging such items during grasping and movement.

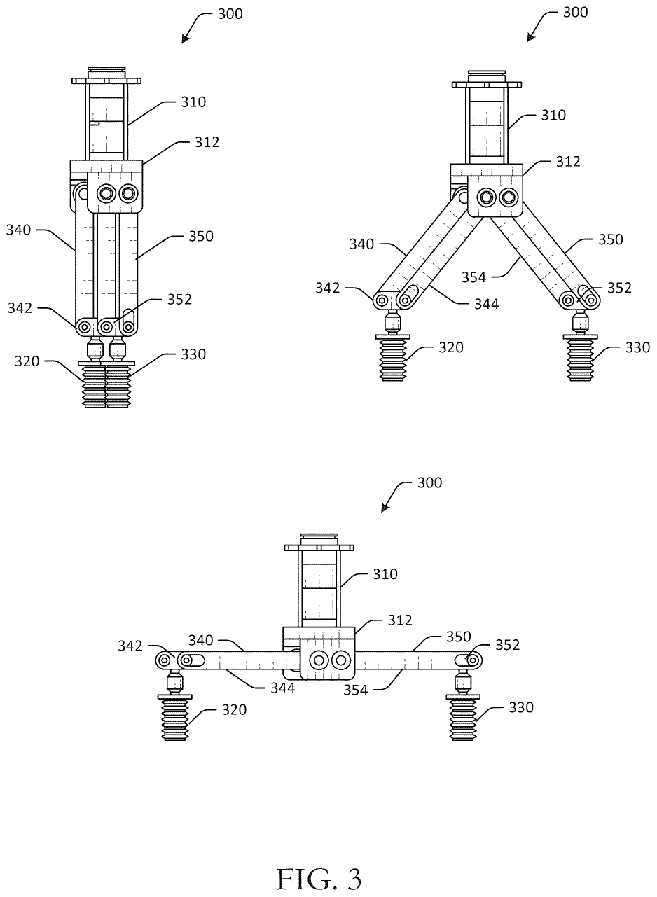

FIG. 3 is a schematic illustration of an item manipulation device 300 in accordance with one or more embodiments of the disclosure. Other embodiments may include additional or fewer components. The illustration of FIG. 3 is not to scale, and may not be illustrated to scale with respect to other figures. The item manipulation device illustrated in FIG. 3 may be the same end of arm tool and/or end effector discussed with respect to FIGS. 1A-2.

In FIG. 3, the item manipulation device 300 may be coupled to a robotic manipulator, such as a robotic arm, a gantry, or other type of manipulator. The item manipulation device 300 may be configured to grasp items in cluttered or uncluttered environments using one or more engagement members and/or one or more suction cups.

For example, the item manipulation device 300 may include a base or housing 310. The housing 310 may form a central body of the item manipulation device 300. The housing 310 can include components of the item manipulation device 300, and may house or otherwise support one or more components of the item manipulation device 300. The housing 310 may house some or all, or none, of the components of the item manipulation device 300. In some embodiments, a center of gravity of the item manipulation device 300 may be disposed along an axial or vertical axis of the housing 310.

The item manipulation device 300 may include a first suction cup assembly 320 having one or more suction cups, and a second suction cup assembly 350 having one or more suction cups. The item manipulation device 300 may include an actuator 312 configured to impart lateral motion to the first suction cup assembly 320 and/or the second suction cup assembly 330. For example, the first suction cup assembly 320 may include a first four-bar linkage 340, 342, 344 coupled to one or more suction cups at a distal end. The second suction cup assembly 350 may include a second four-bar linkage 350, 352, 354 coupled to one or more suction cups at a distal end. As depicted in FIG. 3, the item manipulation device 300 may move from a closed position to a middle position to an expanded position via manipulation of the respective four-bar linkages. During movement between positions, the suction cups may remain downwards-facing and/or horizontal. The actuator 312 may cause movement of one or both the first suction cup assembly 320 and/or the second suction cup assembly 350.

The respective suction cup assemblies 320, 330 may include a first suction cup, a second suction cup, and so forth. The suction cup(s) may be disposed in various patterns or orientations, such as a hexagonal arrangement, a linear arrangement, and so forth. In some embodiments, the suction cup assembly 320 may have a fixed position relative to the four-bar linkages, whereas in other embodiments, one or more of the suction cups of the suction cup assemblies 320, 330 may be extendable relative to the four-bar linkages. For example, one or more pneumatic actuators may be used to cause the suction cups to extend or retract.

The item manipulation device 300 may include one or more engagement members that may be used to grasp, lift, and/or move items such as shoeboxes, books, and the like where the item may have weight that shifts during movement or that is otherwise difficult to grasp. Some embodiments may use engagement members to grasp items from side, upper, and/or lower surfaces.

Accordingly, the item manipulation device 300 may include the housing 310, the first suction cup assembly 320, which can include a first suction cup and a first suction cup support arm formed by the first four-bar linkage 340, 342, 344, where the first suction cup support arm is configured to rotate with respect to the housing 310. The item manipulation device 300 may include the second suction cup assembly 330 having a second suction cup, and a second suction cup support arm formed by the second four-bar linkage 350, 352, 354, where the second suction cup support arm is configured to rotate with respect to the housing 310. At least one of the first suction cup assembly 320 or the second suction cup assembly 330 may be configured to move relative to the other. The item manipulation device 300 may include the first actuator 312 configured to actuate the first suction cup assembly 320 to cause the first suction cup assembly to move relative to the second suction cup assembly 330, or vice versa. The first actuator may be further configured to actuate the second suction cup assembly 330 to cause the second suction cup assembly to move relative to the first suction cup assembly 320. In some embodiments, at least one of the first suction cup assembly 320 or the second suction cup assembly 330 can be configured to move independent of the other. The first suction cup and the second suction cup remain in a downwards-facing orientation throughout a range of motion of the first suction cup assembly 320 and the second suction cup assembly 330, respectively.

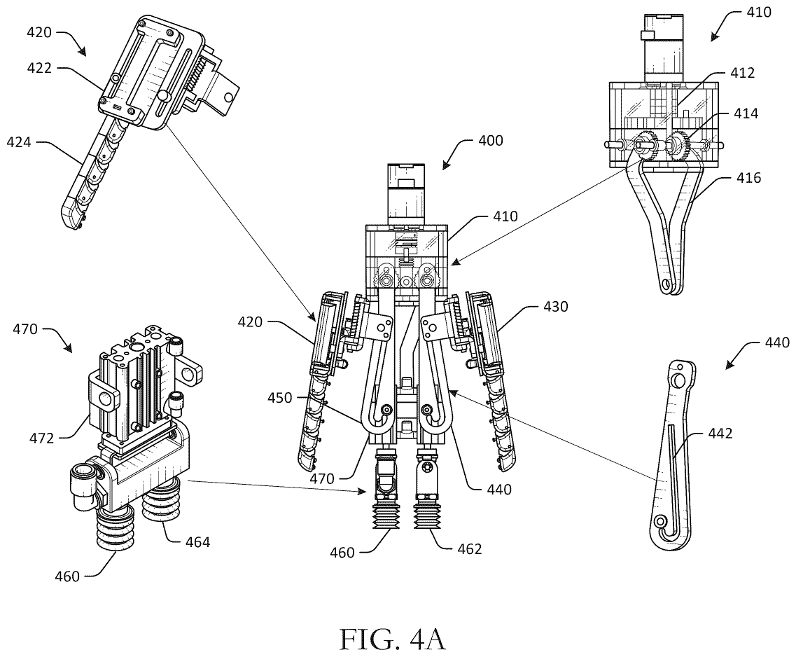

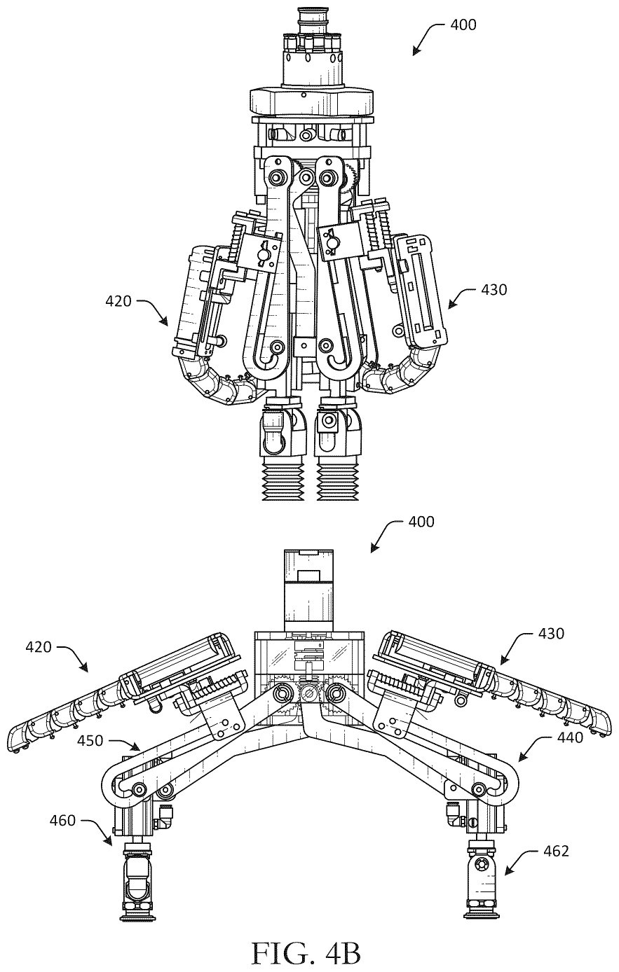

FIGS. 4A-4B are schematic illustrations of an end of arm tool with engagement members and suction cup assemblies in various configurations in accordance with one or more embodiments of the disclosure. Other embodiments may include additional or fewer components. The illustrations of FIGS. 4A-4B are not to scale, and may not be illustrated to scale with respect to other figures. The engagement members and end of arm tools illustrated in FIGS. 4A-4B may be the same engagement members and end of arm tool discussed with respect to FIGS. 1A-3.

In FIG. 4A, an item manipulation device 400 is depicted with various components in isolated view. The item manipulation device 400 may include a housing 410, a first engagement member 420, a second engagement member 430, a first rail 450 having a cam profile along which the first engagement member 420 may move, a second rail 440 having a cam profile 442 along which the second engagement member 430 may move, a first suction cup assembly 470 having a first suction cup 460, and a second suction cup assembly having a second suction cup 462.

The housing 410 may include an actuator 412, such as a motor or other actuator, configured to drive one or more gears 414 that impart motion to respective support arms 416. The support arms 416 may be used to control lateral movement of the respective suction cup assemblies 470.

The first engagement member 420 and/or the second engagement member 430 may be used to grasp lower surfaces and/or apply pressure to upper surfaces of items for caging. Other embodiments may include a single engagement member or more than two engagement members. The first engagement member 420 may be disposed on a first side of the housing 410, and the second engagement member 430 may be disposed on a second side of the housing 410. The first side may be opposite the second side in some instances. Other embodiments may have different positioning of engagement members. In some embodiments, the engagement members may have a fixed vertical position relative to the housing 410 and/or the other engagement member(s). In other embodiments, one or more of the engagement members may be configured to slide along the housing 410. The first engagement member 420 may be configured to slide along the first rail, such that its position relative to the second engagement member 430 and/or the housing 410 may change. The first rail may have a cam mechanism formed therein, where the slot may cause the first engagement member 420 to move in a linear direction, and then at a distal end of the slot, the slot may curve so as to allow the first engagement member 420 to move or rotate in an angular direction (e.g., to form an “open jaw,” etc.). In other embodiments, the first engagement member 420 may have a fixed position relative to the housing 410 and/or the second engagement member 430. The first engagement member 420 may be actuated along the first rail by an actuator 422, which may be a pneumatic actuator or another type of actuator. The actuator 422 may cause the first engagement member 420 to move linearly and rotate. Any number of actuators may be included. The actuators may be pneumatic, motors, servos, or other types of actuators configured to impart motion to the first engagement member 420. The first engagement member 420 may include one or more arm portions 424. The arm portions may be driven or actuated by one or more internal cables. In some embodiments, coupling between arm portions may be via one-way bearings to provide additional rigidity and/or resistance to movement during motion of the robotic manipulator and/or end of arm tool. Additional or fewer arm portions may be included. A distal end of the first engagement member 420 may have various geometries or configurations, and may be in the shape of a finger or nail in some embodiments, and/or may include a rubber pad, a suction cup, or other component to assist in providing grip of an item and/or surface. Other embodiments may have spherical shaped distal ends. In some embodiments, the first engagement member 420 may be devoid of suction or vacuum flow (and corresponding suction cups). For example, the first engagement member 420 may be devoid of a suction cup. Other embodiments may include vacuum flow coupled to the first engagement member 420.

The second engagement member 430 may include the same or similar components as the first engagement member 420, such as a second arm portion configured to rotate with respect to the housing 410, and so forth. The first engagement member 420 may be positioned at the same vertical position or at a different vertical position along the housing 410 than the second engagement member 430. A second actuator may be included to drive movement of the second engagement member 430 along the second rail 440. In some embodiments, the first actuator 422 and the second actuator may cause contraction of the cables in the respective engagement members to form a tight grip around an item.

The item manipulation device 400 may include one or more actuators 472 for the suction cup assembly 470. The suction cup assembly 470 may include more than one suction cup in some embodiments, such as a second suction cup 464. The item manipulation device 400 may include a pneumatic actuator that may provide suction, vacuum force, negative pressure, and/or positive pressure. When actuated, the actuator may cause application of suction, vacuum, or negative pressure to the suction cup assembly 470, such that the suction cup assembly 470 may engage and/or lift a portion of an item. The suction cup assembly 470 may be formed of various materials, such as silicone, rubber, plastics, composites, metals, or combinations thereof. In other example embodiments, the actuator may include various other types of actuators, such as a servo, a solenoid, a motor, or a shape memory alloy.

As depicted at least in FIG. 4B, the item manipulation device 400 may use the first engagement member 420 and/or the second engagement member 430 in various positions, such as a retracted position illustrated in the upper portion of FIG. 4B, and a fully expanded position depicted in the lower portion of FIG. 4B.

Accordingly, the item manipulation device 400 may include a first engagement member having a first arm portion configured to rotate with respect to the housing, and a second arm portion configured to rotate with respect to the first arm portion. The item manipulation device 400 may include a first rail disposed on the housing, where the first engagement member is configured to slide along the first rail, and where the first engagement member is configured to slide along the first rail independent of a second engagement member. In some embodiments, the first engagement member is configured to rotate at least 75 degrees with respect to a central axis of the housing. The first engagement member may be devoid of a suction cup. Some embodiments include a second engagement member having a third arm portion configured to rotate with respect to the housing, and a fourth arm portion configured to rotate with respect to the third arm portion, as well as a second rail disposed on the housing, where the second engagement member is configured to slide along the second rail. A first actuator 412 may be configured to actuate lateral movement of at least one of the first suction cup or the second suction cup, as shown in FIG. 4A. A second actuator 472 may be configured to actuate extension and retraction of the at least one of the first suction cup or the second suction cup. A third actuator 422 may be configured to actuate the first engagement member 420.

As depicted in the open or expanded configuration, the first engagement member 420 may be extended away from the end of arm tool 400. In a closed configuration, the first engagement member 420 may be positioned adjacent to a housing 410 of the end of arm tool 400. For example, in the closed position, the first arm portion and the second arm portion of the first engagement member may be substantially axially aligned or in a substantially linear arrangement (e.g., between 160 and 200 degrees, etc.). This arrangement may allow for improved operation of the end of arm tool 400 when the first engagement member 410 is not in use.

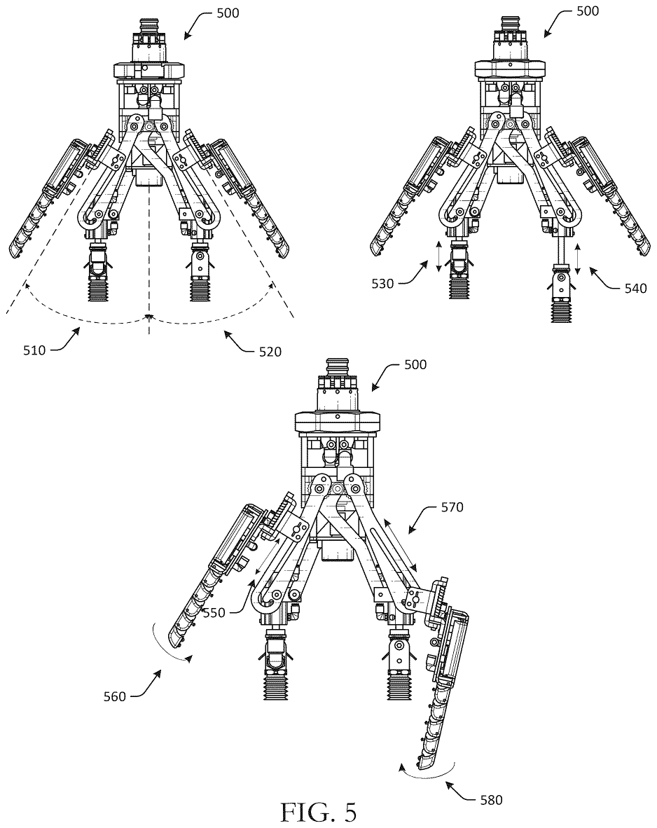

FIG. 5 is a schematic illustration of an end of arm tool with engagement members and suction cup assemblies in various configurations in accordance with one or more embodiments of the disclosure. Other embodiments may include additional or fewer components. The illustration of FIG. 5 is not to scale, and may not be illustrated to scale with respect to other figures. The engagement members and end of arm tool illustrated in FIG. 5 may be the same engagement members and end of arm tool discussed with respect to FIGS. 1A-4B.

In FIG. 5, in a first configuration 500, the end of arm tool is depicted with a first engagement member and a second engagement member in a partially expanded configuration. A first suction cup assembly may have a first angular range of motion 510 and a second suction cup assembly may have a second angular range of motion 520. The respective suction cup assemblies may be configured to move vertically from an extended to a retracted position. For example, the first suction cup may move in directions 530 and the second suction cup may move in directions 540. The engagement members may have additional degrees of freedom. For example, a first engagement member may be configured to move in a third angular direction 560, as well as slide in directions 550, and a second engagement member may be configured to move in a fourth angular direction 580, as well as slide in directions 570.

The respective engagement members may rotate outwards when they slide along the respective rails, where slots formed in the rail create a cam mechanism to cause the engagement members to rotate outwards. The engagement members may be moved axially and rotationally using the same actuator. The actuator may also cause retraction of the engagement members in some embodiments. In other embodiments, another actuator may control contraction or retraction of the engagement members.

To retract the engagement members, the actuators may cause the engagement members to return to a vertical position, and then cause the engagement members to move upwards towards a proximal end of the housing. The engagement members may be independently controlled and/or actuated.

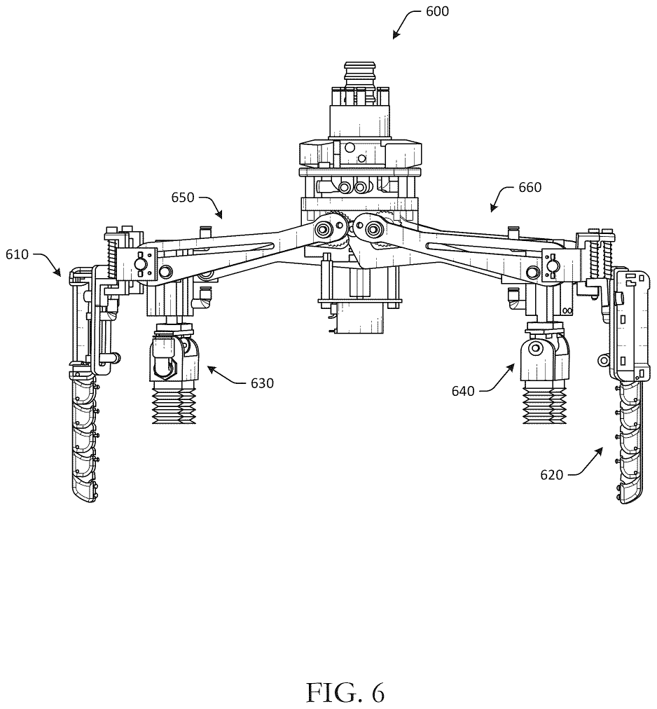

FIG. 6 is a schematic illustration of an end of arm tool in an expanded configuration in accordance with one or more embodiments of the disclosure. Other embodiments may include additional or fewer components. The illustration of FIG. 6 is not to scale, and may not be illustrated to scale with respect to other figures. The engagement members and end of arm tool illustrated in FIG. 5 may be the same engagement members and end of arm tool discussed with respect to FIGS. 1A-5.

In FIG. 6, an end of arm tool 600 may include a first engagement member 610, a first suction cup assembly 630, and a first four-bar linkage 650. The first four-bar linkage 650 may be configured to move the first suction cup assembly 630 and/or the first engagement member 610. The first engagement member 610 may be configured to move along a rail that may be part of the first four-bar linkage 650 or may be a discrete component.

The end of arm tool 600 may include a second engagement member 620, a second suction cup assembly 640, and a second four-bar linkage 660. The second four-bar linkage 660 may be configured to move the second suction cup assembly 640 and/or the second engagement member 620. The second engagement member 620 may be configured to move along a rail that may be part of the second four-bar linkage 660 or may be a discrete component.

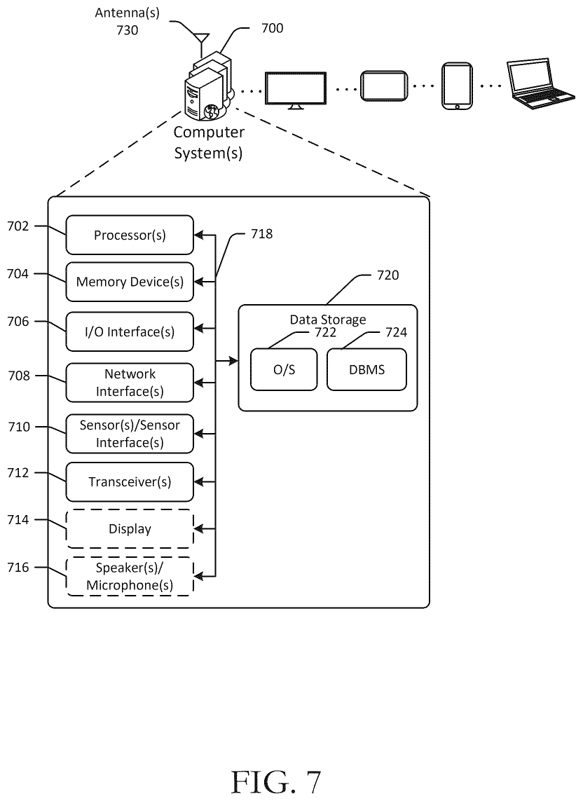

The end of arm tool 600 may be for an item manipulation device, and the end of arm tool may include a housing, a first suction cup assembly having a first suction cup, and a first suction cup support arm, where the first suction cup support arm is configured to rotate with respect to the housing, and a second suction cup assembly having a second suction cup, and a second suction cup support arm, where the second suction cup support arm is configured to rotate with respect to the housing. At least one of the first suction cup assembly or the second suction cup assembly can configured to move independent of the other. The end of arm tool 600 may include or may be coupled to a controller, such as that discussed with respect to FIG. 7. The controller may be configured to determine an item is in a first position, cause the first suction cup to be actuated to a first lateral position based on the first position, cause the second suction cup to be actuated to a second lateral position based on the first position, and determine that the item is grasped.

One or more operations of the methods, process flows, or use cases of FIGS. 1A-6 may have been described above as being performed by an item manipulation device, or more specifically, by one or more program module(s), applications, or the like executing on a device. It should be appreciated, however, that any of the operations of the methods, process flows, or use cases of FIGS. 1A-6 may be performed, at least in part, in a distributed manner by one or more other devices, or more specifically, by one or more program module(s), applications, or the like executing on such devices. In addition, it should be appreciated that processing performed in response to the execution of computer-executable instructions provided as part of an application, program module, or the like may be interchangeably described herein as being performed by the application or the program module itself or by a device on which the application, program module, or the like is executing. While the operations of the methods, process flows, or use cases of FIGS. 1A-6 may be described in the context of the illustrative devices, it should be appreciated that such operations may be implemented in connection with numerous other device configurations.

The operations described and depicted in the illustrative methods, process flows, and use cases of FIGS. 1A-6 may be carried out or performed in any suitable order, such as the depicted orders, as desired in various example embodiments of the disclosure. Additionally, in certain example embodiments, at least a portion of the operations may be carried out in parallel. Furthermore, in certain example embodiments, less, more, or different operations than those depicted in FIGS. 1A-6 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by the execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

### Illustrative Computer Architecture

FIG. 7 is a schematic block diagram of one or more illustrative computer system(s) 700 in accordance with one or more example embodiments of the disclosure. The computer system(s) 700 may include any suitable computing device including, but not limited to, a server system, a voice interaction device, a mobile device such as a smartphone, a tablet, an e-reader, a wearable device, or the like; a desktop computer; a laptop computer; a content streaming device; or the like. The computer system(s) 700 may correspond to an illustrative device configuration for the device(s) of FIGS. 1A-6. For example, the computer system(s) 700 may control one or more aspects of the robotic manipulators and/or end of arm tools described in FIGS. 1A-6, such as determining whether items are grasped, determining end of arm tool positioning, determining when and what distance to extend engagement members, determine when and how long to actuate suction cups, determining individual suction cup assembly positioning, and so forth.

The computer system(s) 700 may be configured to communicate with one or more servers, user devices, cameras, or the like. The computer system(s) 700 may be configured to identify items, retrieve items or containers, move items or containers, and so forth.

The computer system(s) 700 may be configured to communicate via one or more networks. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the computer system(s) 700 may include one or more processors (processor(s)) 702, one or more memory devices 704 (also referred to herein as memory 704), one or more input/output (I/O) interface(s) 706, one or more network interface(s) 708, one or more sensor(s) or sensor interface(s) 710, one or more transceiver(s) 712, one or more optional display(s) 714, one or more optional microphone(s) 716, and data storage 720. The computer system(s) 700 may further include one or more bus(es) 718 that functionally couple various components of the computer system(s) 700. The computer system(s) 700 may further include one or more antenna(s) 730 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 718 may include at least one of a system bus, a memory bus, an address bus, or a message bus, and may permit the exchange of information (e.g., data (including computer-executable code), signaling, etc.) between various components of the computer system(s) 700. The bus(es) 718 may include, without limitation, a memory bus or a memory controller, a peripheral bus, an accelerated graphics port, and so forth. The bus(es) 718 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnect (PCI) architecture, a PCI-Express architecture, a Personal Computer Memory Card International Association (PCMCIA) architecture, a Universal Serial Bus (USB) architecture, and so forth.

The memory 704 of the computer system(s) 700 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 704 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 704 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 720 may include removable storage and/or non-removable storage including, but not limited to, magnetic storage, optical disk storage, and/or tape storage. The data storage 720 may provide non-volatile storage of computer-executable instructions and other data. The memory 704 and the data storage 720, removable and/or non-removable, are examples of computer-readable storage media (CRSM) as that term is used herein.

The data storage 720 may store computer-executable code, instructions, or the like that may be loadable into the memory 704 and executable by the processor(s) 702 to cause the processor(s) 702 to perform or initiate various operations. The data storage 720 may additionally store data that may be copied to the memory 704 for use by the processor(s) 702 during the execution of the computer-executable instructions. Moreover, output data generated as a result of execution of the computer-executable instructions by the processor(s) 702 may be stored initially in the memory 704, and may ultimately be copied to the data storage 720 for non-volatile storage.

More specifically, the data storage 720 may store one or more operating systems (O/S) 722; one or more database management systems (DBMS) 724; and one or more program module(s), applications, engines, computer-executable code, scripts, or the like. Some or all of these module(s) may be sub-module(s). Any of the components depicted as being stored in the data storage 720 may include any combination of software, firmware, and/or hardware. The software and/or firmware may include computer-executable code, instructions, or the like that may be loaded into the memory 704 for execution by one or more of the processor(s) 702. Any of the components depicted as being stored in the data storage 720 may support functionality described in reference to corresponding components named earlier in this disclosure.

The data storage 720 may further store various types of data utilized by the components of the computer system(s) 700. Any data stored in the data storage 720 may be loaded into the memory 704 for use by the processor(s) 702 in executing computer-executable code. In addition, any data depicted as being stored in the data storage 720 may potentially be stored in one or more datastore(s) and may be accessed via the DBMS 724 and loaded in the memory 704 for use by the processor(s) 702 in executing computer-executable code. The datastore(s) may include, but are not limited to, databases (e.g., relational, object-oriented, etc.), file systems, flat files, distributed datastores in which data is stored on more than one node of a computer network, peer-to-peer network datastores, or the like.

The processor(s) 702 may be configured to access the memory 704 and execute the computer-executable instructions loaded therein. For example, the processor(s) 702 may be configured to execute the computer-executable instructions of the various program module(s), applications, engines, or the like of the computer system(s) 700 to cause or facilitate various operations to be performed in accordance with one or more embodiments of the disclosure. The processor(s) 702 may include any suitable processing unit capable of accepting data as input, processing the input data in accordance with stored computer-executable instructions, and generating output data. The processor(s) 702 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 702 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 702 may be capable of supporting any of a variety of instruction sets.

Referring now to other illustrative components depicted as being stored in the data storage 720, the O/S 722 may be loaded from the data storage 720 into the memory 704 and may provide an interface between other application software executing on the computer system(s) 700 and the hardware resources of the computer system(s) 700. More specifically, the O/S 722 may include a set of computer-executable instructions for managing the hardware resources of the computer system(s) 700 and for providing common services to other application programs (e.g., managing memory allocation among various application programs). In certain example embodiments, the O/S 722 may control execution of the other program module(s). The O/S 722 may include any operating system now known or which may be developed in the future including, but not limited to, any server operating system, any mainframe operating system, or any other proprietary or non-proprietary operating system.

The DBMS 724 may be loaded into the memory 704 and may support functionality for accessing, retrieving, storing, and/or manipulating data stored in the memory 704 and/or data stored in the data storage 720. The DBMS 724 may use any of a variety of database models (e.g., relational model, object model, etc.) and may support any of a variety of query languages. The DBMS 724 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the computer system(s) 700 is a mobile device, the DBMS 724 may be any suitable lightweight DBMS optimized for performance on a mobile device.

Referring now to other illustrative components of the computer system(s) 700, the input/output (I/O) interface(s) 706 may facilitate the receipt of input information by the computer system(s) 700 from one or more I/O devices as well as the output of information from the computer system(s) 700 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the computer system(s) 700 or may be separate. The I/O devices may further include, for example, any number of peripheral devices such as data storage devices, printing devices, and so forth.

The I/O interface(s) 706 may also include an interface for an external peripheral device connection such as universal serial bus (USB), FireWire, Thunderbolt, Ethernet port or other connection protocol that may connect to one or more networks. The I/O interface(s) 706 may also include a connection to one or more of the antenna(s) 730 to connect to one or more networks via a wireless local area network (WLAN) (such as Wi-Fi) radio, Bluetooth, ZigBee, and/or a wireless network radio, such as a radio capable of communication with a wireless communication network such as a Long Term Evolution (LTE) network, WiMAX network, 3G network, a ZigBee network, etc.

The computer system(s) 700 may further include one or more network interface(s) 708 via which the computer system(s) 700 may communicate with any of a variety of other systems, platforms, networks, devices, and so forth. The network interface(s) 708 may enable communication, for example, with one or more wireless routers, one or more host servers, one or more web servers, and the like via one or more networks.

The antenna(s) 730 may include any suitable type of antenna depending, for example, on the communications protocols used to transmit or receive signals via the antenna(s) 730. Non-limiting examples of suitable antennas may include directional antennas, non-directional antennas, dipole antennas, folded dipole antennas, patch antennas, multiple-input multiple-output (MIMO) antennas, or the like. The antenna(s) 730 may be communicatively coupled to one or more transceivers 712 or radio components to which or from which signals may be transmitted or received.

As previously described, the antenna(s) 730 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA 2000, etc.), 4G standards (e.g., Long-Term Evolution (LTE), WiMax, etc.), direct satellite communications, or the like.

The antenna(s) 730 may additionally, or alternatively, include a Wi-Fi antenna configured to transmit or receive signals in accordance with established standards and protocols, such as the IEEE 802.11 family of standards, including via 2.4 GHz channels (e.g., 802.11b, 802.11g, 802.11n), 5 GHz channels (e.g., 802.11n, 802.11ac), or 60 GHz channels (e.g., 802.11ad). In alternative example embodiments, the antenna(s) 730 may be configured to transmit or receive radio frequency signals within any suitable frequency range forming part of the unlicensed portion of the radio spectrum.

The antenna(s) 730 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The transceiver(s) 712 may include any suitable radio component(s) for—in cooperation with the antenna(s) 730—transmitting or receiving radio frequency (RF) signals in the bandwidth and/or channels corresponding to the communications protocols utilized by the computer system(s) 700 to communicate with other devices. The transceiver(s) 712 may include hardware, software, and/or firmware for modulating, transmitting, or receiving—potentially in cooperation with any of antenna(s) 730—communications signals according to any of the communications protocols discussed above including, but not limited to, one or more Wi-Fi and/or Wi-Fi direct protocols, as standardized by the IEEE 802.11 standards, one or more non-Wi-Fi protocols, or one or more cellular communications protocols or standards. The transceiver(s) 712 may further include hardware, firmware, or software for receiving GNSS signals. The transceiver(s) 712 may include any known receiver and baseband suitable for communicating via the communications protocols utilized by the computer system(s) 700. The transceiver(s) 712 may further include a low noise amplifier (LNA), additional signal amplifiers, an analog-to-digital (A/D) converter, one or more buffers, a digital baseband, or the like.

The sensor(s)/sensor interface(s) 710 may include or may be capable of interfacing with any suitable type of sensing device such as, for example, inertial sensors, force sensors, thermal sensors, photocells, and so forth. Example types of inertial sensors may include accelerometers (e.g., MEMS-based accelerometers), gyroscopes, and so forth.

The optional display(s) 714 may be configured to output light and/or render content. The optional speaker(s)/microphone(s) 716 may be any device configured to receive analog sound input or voice data.

It should be appreciated that the program module(s), applications, computer-executable instructions, code, or the like depicted in FIG. 7 as being stored in the data storage 720 are merely illustrative and not exhaustive and that processing described as being supported by any particular module may alternatively be distributed across multiple module(s) or performed by a different module. In addition, various program module(s), script(s), plug-in(s), Application Programming Interface(s) (API(s)), or any other suitable computer-executable code hosted locally on the computer system(s) 700, and/or hosted on other computing device(s) accessible via one or more networks, may be provided to support functionality provided by the program module(s), applications, or computer-executable code depicted in FIG. 7 and/or additional or alternate functionality. Further, functionality may be modularized differently such that processing described as being supported collectively by the collection of program module(s) depicted in FIG. 7 may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) depicted in FIG. 7 may be implemented, at least partially, in hardware and/or firmware across any number of devices.

It should further be appreciated that the computer system(s) 700 may include alternate and/or additional hardware, software, or firmware components beyond those described or depicted without departing from the scope of the disclosure. More particularly, it should be appreciated that software, firmware, or hardware components depicted as forming part of the computer system(s) 700 are merely illustrative and that some components may not be present or additional components may be provided in various embodiments. While various illustrative program module(s) have been depicted and described as software module(s) stored in the data storage 720, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed is:

1. A system comprising:
a robotic manipulator; and
an item manipulation device coupled to the robotic manipulator, the item manipulation device comprising:
a housing;
a first suction cup assembly comprising:
a first suction cup; and
a first suction cup support arm, wherein the first suction cup support arm is configured to rotate with respect to the housing;
a second suction cup assembly comprising:
a second suction cup;
a second suction cup support arm, wherein second suction cup support arm is configured to rotate with respect to the housing;
wherein at least one of the first suction cup assembly or the second suction cup assembly is configured to move relative to the other; and a first engagement member comprising:
a first arm portion configured to rotate with respect to the housing; and
a second arm portion configured to rotate with respect to the first arm portion; and
a first rail disposed on the housing, wherein the first engagement member is configured to slide along the first rail;
wherein the first engagement member is configured to slide along the first rail independent of a second engagement member.

2. The system of claim 1, wherein the first suction cup and the second suction cup remain in a downwards-facing orientation throughout a range of motion of the first suction cup assembly and the second suction cup assembly, respectively.

3. The system of claim 1, further comprising:
a first actuator configured to actuate lateral movement of at least one of the first suction cup or the second suction cup;
a second actuator configured to actuate extension and retraction of the at least one of the first suction cup or the second suction cup; and
a third actuator configured to actuate the first engagement member.

4. The system of claim 1, further comprising:
a controller configured to:
determine an item is in a first position;
cause the first suction cup to be actuated to a first lateral position based on the first position;
cause the second suction cup to be actuated to a second lateral position based on the first position; and
determine that the item is grasped.

5. An item manipulation device comprising:
a housing;
a first suction cup assembly comprising:
a first suction cup; and
a first suction cup support arm, wherein the first suction cup support arm is configured to rotate with respect to the housing; and
a second suction cup assembly comprising:
a second suction cup; and
a second suction cup support arm, wherein the second suction cup support arm is configured to rotate with respect to the housing;
wherein at least one of the first suction cup assembly or the second suction cup assembly is configured to move relative to the other.

6. The item manipulation device of claim 5, further comprising:
a first actuator configured to actuate the first suction cup assembly to cause the first suction cup assembly to move relative to the second suction cup assembly.

7. The item manipulation device of claim 6, wherein the first actuator is further configured to actuate the second suction cup assembly to cause the second suction cup assembly to move relative to the first suction cup assembly.

8. The item manipulation device of claim 5, further comprising:
a first engagement member comprising:
a first arm portion configured to rotate with respect to the housing; and
a second arm portion configured to rotate with respect to the first arm portion; and
a first rail disposed on the housing, wherein the first engagement member is configured to slide along the first rail;
wherein the first engagement member is configured to slide along the first rail independent of a second engagement member.

9. The item manipulation device of claim 8, wherein the first engagement member is configured to rotate at least 75 degrees with respect to a central axis of the housing.

10. The item manipulation device of claim 8, further comprising:
a second engagement member comprising:
a third arm portion configured to rotate with respect to the housing; and
a fourth arm portion configured to rotate with respect to the third arm portion; and
a second rail disposed on the housing, wherein the second engagement member is configured to slide along the second rail.

11. The item manipulation device of claim 8, wherein the first engagement member is devoid of a suction cup.

12. The item manipulation device of claim 8, further comprising:
a first actuator configured to actuate lateral movement of at least one of the first suction cup or the second suction cup;
a second actuator configured to actuate extension and retraction of the at least one of the first suction cup or the second suction cup; and
a third actuator configured to actuate the first engagement member.

13. The item manipulation device of claim 5, wherein at least one of the first suction cup assembly and the second suction cup assembly is configured to move independent of the other.

14. The item manipulation device of claim 5, wherein the first suction cup and the second suction cup remain in a downwards-facing orientation throughout a range of motion of the first suction cup assembly and the second suction cup assembly, respectively.

15. The item manipulation device of claim 5, further comprising:
a controller configured to:
determine an item is in a first position;
cause the first suction cup to be actuated to a first lateral position based on the first position;
cause the second suction cup to be actuated to a second lateral position based on the first position; and
determine that the item is grasped.

16. An end of arm tool for an item manipulation device, the end of arm tool comprising:
a housing;
a first suction cup assembly comprising:
a first suction cup; and
a first suction cup support arm, wherein the first suction cup support arm is configured to rotate with respect to the housing; and
a second suction cup assembly comprising:
a second suction cup; and
a second suction cup support arm, wherein the second suction cup support arm is configured to rotate with respect to the housing;
wherein at least one of the first suction cup assembly or the second suction cup assembly is configured to move independent of the other.

17. The end of arm tool of claim 16, further comprising:
a first actuator configured to (i) actuate the first suction cup assembly to cause the first suction cup assembly to move relative to the second suction cup assembly, and (ii) actuate the second suction cup assembly to cause the second suction cup assembly to move relative to the first suction cup assembly.

18. The end of arm tool of claim 16, further comprising:
a first engagement member comprising:
a first arm portion configured to rotate with respect to the housing; and
a second arm portion configured to rotate with respect to the first arm portion; and
a first rail disposed on the housing, wherein the first engagement member is configured to slide along the first rail;
wherein the first engagement member is configured to slide along the first rail independent of a second engagement member.

19. The end of arm tool of claim 18, further comprising:
a first actuator configured to actuate lateral movement of at least one of the first suction cup or the second suction cup;
a second actuator configured to actuate extension and retraction of the at least one of the first suction cup or the second suction cup; and
a third actuator configured to actuate the first engagement member.

20. The end of arm tool of claim 16, wherein the first suction cup and the second suction cup remain in a downwards-facing orientation throughout a range of motion of the first suction cup assembly and the second suction cup assembly, respectively.
